(19) United States
(12) Patent Application Publication
(10) Pub. No.: US 2025/0360717 A1
(43) Pub. Date: Nov. 27, 2025

(54) IMAGE FORMING APPARATUS AND CONTROL METHOD

(71) Applicant: CANON KABUSHIKI KAISHA, Tokyo (JP)

(72) Inventors: RUI SEKINE, Kanagawa (JP); YOSHIKAZU SAITO, Tokyo (JP); ATSUSHI SAKAMOTO, Kanagawa (JP); NORIBUMI KOITABASHI, Kanagawa (JP)

(21) Appl. No.: 19/212,954

(22) Filed: May 20, 2025

(30) Foreign Application Priority Data
May 23, 2024 (JP) 2024-084365

(51) Int. Cl. B41J 2/165

(52) U.S. Cl. CPC B41J 2/16552; B41J 2/16532; B41J 2002/16558; B41J 2002/16594; B41P 2235/21; B41P 2235/27

(57) ABSTRACT

A technique capable of increasing cleanability. Included are a printing unit configured to eject a printing liquid from a nozzle to perform printing and a maintenance unit configured to wipe a nozzle surface on which the nozzle is formed in the printing unit to remove a deposit deposited on the nozzle surface. The maintenance unit includes a first wiping portion configured to give a first wipe with a first blade made of an elastic material and a second wiping portion configured to give a second wipe with a second blade made of an elastic material different from that of the first blade, and the second blade has a hardness lower than that of the first blade and is formed thicker than the first blade.

### BACKGROUND OF THE INVENTION

### Cross Reference to Priority Application

This application claims the benefit of Japanese Patent Application No. 2024-084365, filed May 23, 2024, which is hereby incorporated by reference herein in its entirety.

### FIELD OF THE INVENTION

The present disclosure relates to an image forming apparatus and a control method.

### DESCRIPTION OF THE RELATED ART

An inkjet printing apparatus serving as an image forming apparatus for forming an image on a print medium includes a constituent for wiping off any deposits such as an ink and paper powder that have deposited on a nozzle surface on which a nozzle is formed to satisfactorily maintain and recover the performance of ink ejection from the nozzle of a print head.

Japanese Patent Laid-Open No. 2007-203679 discloses a technique for increasing the cleanability of a nozzle guard by forming a portion of a blade for wiping the nozzle guard that protects an area where a nozzle is formed, thicker than the portion for wiping the area.

However, in the technique disclosed in Japanese Patent Laid-Open No. 2007-203679, in order to increase the cleanability for the area where the nozzle is formed, it is necessary to increase the contact force of the blade on the area, and in this case, contact force on another area where the nozzle guard and the like are located also increases. Thus, excessive contact force is applied to the other area, which may damage a member located in the other area or the blade itself.

### SUMMARY OF THE INVENTION

The present disclosure is made in view of the above problem and provides a technique capable of increasing cleanability.

An image forming apparatus includes a printing unit configured to eject a printing liquid from a nozzle to perform printing; and a maintenance unit configured to wipe a nozzle surface on which the nozzle is formed in the printing unit to remove a deposit deposited on the nozzle surface, wherein the maintenance unit includes a first wiping portion configured to give a first wipe with a first blade made of an elastic material; and a second wiping portion configured to give a second wipe with a second blade made of an elastic material different from that of the first blade, wherein the second blade has a hardness lower than that of the first blade and is formed thicker than the first blade.

According to the present disclosure, it is possible to increase cleanability.

Further features of the present invention will become apparent from the following description of exemplary embodiments with reference to the attached drawings.

### BRIEF DESCRIPTION OF THE DRAWINGS

FIG. 1 is a schematic configuration diagram of an image forming apparatus.

FIG. 2 is a diagram showing a conveyance path in a printing portion.

FIG. 3 is a schematic configuration diagram of an elevator that elevates and lowers a print head.

FIG. 4 is a perspective configuration diagram of the print head.

FIGS. 5A to 5C are diagrams for explaining a configuration of a nozzle surface.

FIG. 6 is a diagram showing a maintenance portion in a case where the print head is positioned.

FIG. 7 is a cross-sectional view taken along line VII-VII in FIG. 6.

FIG. 8 is a schematic configuration diagram of a maintenance member.

FIGS. 9A and 9B are image diagrams showing intrusion of a blade into an opening.

FIG. 10 is a graph showing a relationship between contact force on a surface and contact force on the periphery of a nozzle array.

FIG. 11 is a flowchart showing the processing contents of a first cleaning process.

FIG. 12 is a flowchart showing the processing contents of a second cleaning process.

FIG. 13 is a table showing the properties of a rubber material used for blade formation in an experiment.

FIG. 14 is a table showing experimental conditions and experimental results.

### DESCRIPTION OF THE EMBODIMENTS

Hereafter, an example of an embodiment of an image forming apparatus and a control method will be described with reference to the attached drawings. Incidentally, the following embodiments do not limit the present disclosure, and not all of combinations of features described in the present embodiments are necessarily essential to a solution to the problem to be solved by the present disclosure. Further, the positions, shapes, and the like of constituents described in the embodiments are merely examples and are not intended to limit the present disclosure only thereto.

### Configuration of Printing Apparatus

First, the configuration of a printing apparatus serving as an image forming apparatus according to the present embodiment will be described. In the present embodiment, a high-speed line printer which is capable of high-speed printing and is a printer that applies an ink to a sheet unwound from a roll formed by winding a continuous sheet to print an image or the like will be described as an example of the image forming apparatus.

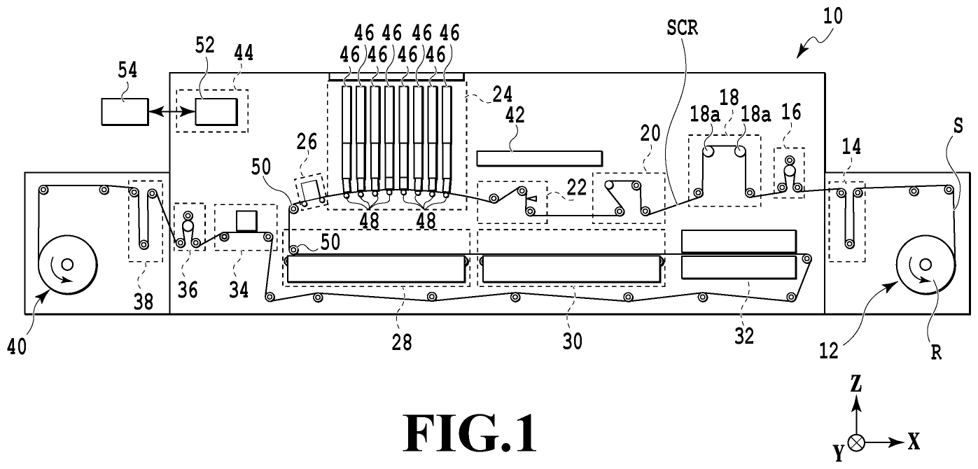

FIG. 1 is a schematic configuration diagram of the printing apparatus which is the image forming apparatus according to the present embodiment. In the present specification, a sheet conveyance direction (the left-and-right direction in FIG. 1) is an X direction, a sheet width direction (a direction perpendicular to a sheet surface in FIG. 1) is a Y direction, and the up-and-down direction of the printing apparatus (the up-and-down direction in FIG. 1) is a Z direction. The X direction, Y direction, and Z direction are orthogonal to each other. Further, for each direction, a direction from one side to the other side is appropriately indicated with “+” and a direction from the other side to the one side is appropriately indicated with “-.”

The printing apparatus 10 includes an unwinding roll portion 12 that holds a roll R, a first dancer portion 14 that applies tension to a sheet S, a first primary conveyance portion 16 that conveys the sheet S, and a meander correction portion 18 that corrects the sheet S's meandering in the Y direction. The printing apparatus 10 also includes a conveyance detection portion 20 that detects the tension applied to the sheet S, a mark sensor portion 22 that detects a mark printed on the sheet S, and a printing portion 24 that applies an ink to the sheet S to perform printing. The printing apparatus 10 further includes a first scanner portion 26 that reads a printed image printed on the sheet S, a first drying portion 28 and a second drying portion 30 that dry the ink applied to the sheet S, and a cooling portion 32 that cools the sheet S.

The printing apparatus 10 includes a second scanner portion 34 that reads a test image printed on the sheet S, a second primary conveyance portion 36 that conveys the sheet S, and a second dancer portion 38 that applies tension to the sheet S. The printing apparatus 10 also includes a wind-up roll portion 40 that winds up the printed sheet S, a maintenance portion 42 that performs maintenance processing for maintaining and recovering the ejection performance of the printing portion 24, and a control portion 44 that controls the entire printing apparatus 10. The sheet S is conveyed along a sheet conveyance route SCR indicated by a solid line in FIG. 1, and each of the above constituent members performs processing on the sheet S.

More specifically, the unwinding roll portion 12 is configured to unwind the stored roll R and supply the sheet S pulled out from the roll R to the first dancer portion 14. It should be noted that although FIG. 1 shows that one roll R is held, two or more rolls R may be held to selectively pull out and supply the sheet S from the plurality of stored rolls R.

The first dancer portion 14 applies constant tension to the sheet S with a tension application unit (not shown) between the unwinding roll portion 12 and the first primary conveyance portion 16. The first primary conveyance portion 16 also feeds the sheet S to a subsequent constituent member and applies predetermined tension to the sheet S in cooperation with the second primary conveyance portion 36. The first primary conveyance portion 16 rotates by driving a motor (not shown) and conveys the sheet S while applying tension to the sheet S.

The meander correction portion 18 corrects the sheet S's meandering in the Y direction in conveying the sheet S to which tension has been applied. The meander correction portion 18 includes a correction roller 18a and a meander detection sensor (not shown) that detects the sheet S's meandering. The correction roller 18a can change the inclination of the sheet S in the Y direction with a motor (not shown) and corrects the sheet S's meandering based on the results of measurement made by the meander detection sensor. At this time, the sheet is wound around the correction roller 18a, thereby enhancing the meander correction function. The meander correction portion 18 can return the conveyance direction of the sheet S that has meandered in the Y direction to a normal conveyance direction.

The conveyance detection portion 20 detects the tension of the sheet S conveyed between the first primary conveyance portion 16 and the second primary conveyance portion 36. The conveyance detection portion 20 also detects the conveyance speed of the sheet S to control the timing of printing by the printing portion 24. The mark sensor portion 22 detects a mark previously printed on the sheet S to control the timing of printing by the printing portion 24. The printing portion 24 includes a print head 46 that ejects an ink from an upper side onto the conveyed sheet S. A conveyance route (a conveyance path 202 described later) in the printing portion 24 is formed into an upwardly convex arc shape by arranging a plurality of guide rollers 48. Tension is then applied to the sheet S, so that clearance is secured between the sheet S conveyed on the conveyance route and the print head 46.

The first scanner portion 26 reads the image printed on the sheet S by the printing portion 24 to detect image misalignment and the density of the image. Detection results based on the reading by the first scanner portion 26 are used for correction of printing by the printing portion 24, such as, position correction and color tone correction.

Both the first drying portion 28 and the second drying portion 30 are configured to reduce a liquid component contained in an ink applied to the sheet S by the printing portion 24 and to increase fixability between the sheet S and the ink. The second drying portion 30 is arranged downstream of the first drying portion 28 in a direction in which the sheet S is conveyed. The first drying portion 28 and the second drying portion 30 dry an ink by heating. Specifically, an ink is dried by applying hot air to the sheet S being conveyed at least from an ink application surface side. Incidentally, the drying method is not limited to a method for applying hot air, but various known methods such as a method for irradiating electromagnetic waves (such as ultraviolet rays and infrared rays) and a conductive heat transfer method using contact with a heating element may be used, or a combination of a plurality of methods may be used.

A wrapping guide roller 50 is provided between the first scanner portion 26 and the first drying portion 28. The wrapping guide roller 50 is a roller around which the back surface opposite to the ink application surface of the sheet S is wrapped at a constant wrapping angle on the downstream side of the printing portion 24 in the conveyance direction in order to suppress the influence of hot air generated in the first drying portion 28 on the printing portion 24. In the present embodiment, the sheet conveyance route SCR is folded back by the wrapping guide roller 50 so as to be arranged approximately parallel and one above the other. The first drying portion 28 is arranged below the printing portion 24, and the second drying portion 30 is arranged below the conveyance detection portion 20 and the mark sensor portion 22.

The cooling portion 32 is configured to cool the sheet S heated by the first drying portion 28 and the second drying portion 30, solidify an ink softened by the heating in the sheet S, and suppress temperature changes in the sheet S across constituent members downstream in the conveyance direction. The cooling portion 32 cools the sheet S by applying air cooler than the sheet S to at least the ink application surface side of the sheet S being conveyed. The cooling method is not limited to the method for applying cold air, but various known methods such as a conductive heat transfer method using contact with a heat dissipation member may be used, or a combination of a plurality of methods may be used.

The second scanner portion 34 reads a test image printed on the sheet S by the printing portion 24 before job-based printing and detects image misalignment and the density of the image. Detection results based on the reading by the second scanner portion 34 are used to correct the job-based printing.

The second primary conveyance portion 36 is a member that functions in cooperation with the first primary conveyance portion 16 and adjusts tension applied to the sheet S while conveying the sheet S. The second primary conveyance portion 36 rotates by driving a motor (not shown). The tension of the sheet S is adjusted with a clutch (not shown) that is driven and coupled and can control torque based on a tension value detected by a tension control portion (not shown). It should be noted that, as an additional configuration for adjusting the tension of the sheet S, a configuration for controlling the drive speed of the second primary conveyance portion 36 based on the results of detection by the conveyance detection portion 20 may be provided. As a method for implementing such a configuration, either a torque control method for controlling the value of torque transmitted from the clutch or a speed control method for controlling the drive speed of the second primary conveyance portion 36 may be used. Alternatively, these two methods may be switched according to the purpose, or the two methods may be used simultaneously.

The second dancer portion 38 is configured to apply constant tension to the sheet S with a tension application unit (not shown) between the second primary conveyance portion 36 and the winding roll portion 40. The winding roll portion 40 is configured to wind the conveyed and printed sheet S around a winding core. Incidentally, although FIG. 1 shows that only one collectable winding core is provided, the number of winding cores is not limited to one, and a plurality of winding cores may be provided and selectively switched to collect the sheet S.

The maintenance portion 42 includes a member for maintaining and recovering the ink ejection performance of the print head 46. The maintenance portion 42 includes, for example, a cap (not shown) for protecting a nozzle surface on which a nozzle for ejecting an ink is formed in the print head 46 and a maintenance member 602 (described later) for removing and cleaning deposits such as an ink and paper powder deposited on the nozzle surface. It should be noted that the maintenance portion 42 may include various known members other than the members described above as long as the maintenance portion 42 can maintain and recover the ink ejection performance of the print head 46.

The control portion 44 includes a CPU, a storage device such as a ROM and a RAM, a controller, an external interface, and an operation portion 52 for a user to do input and output. The operation of the printing apparatus 10 is controlled by the controller based on a command input via the operation portion 52 or a command from a host device 54 such as a host computer connected via an external interface.

### Printing Portion

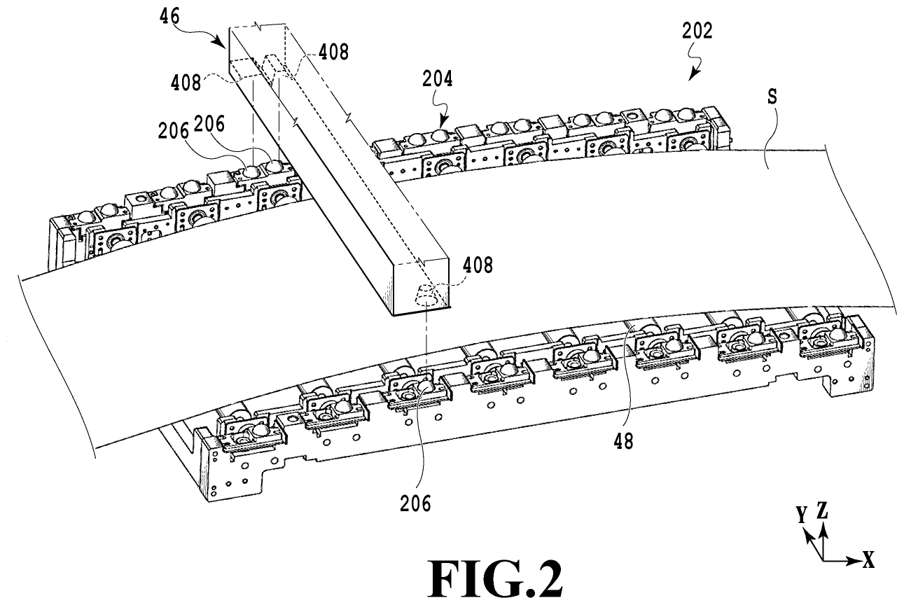

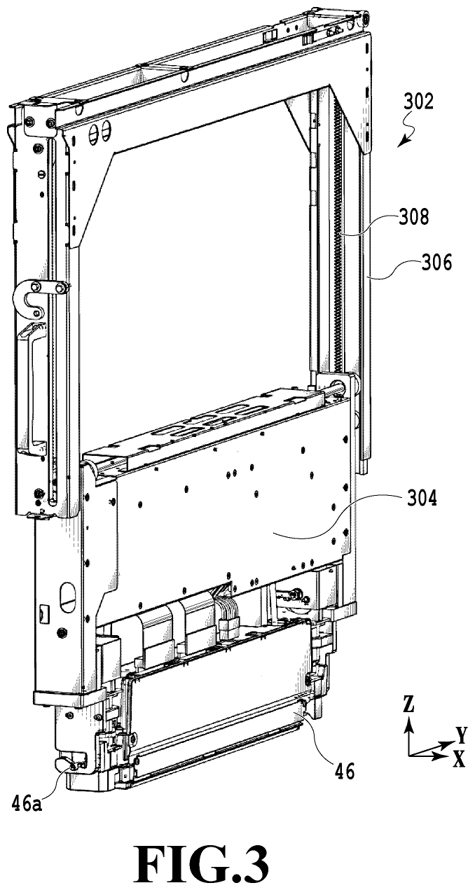

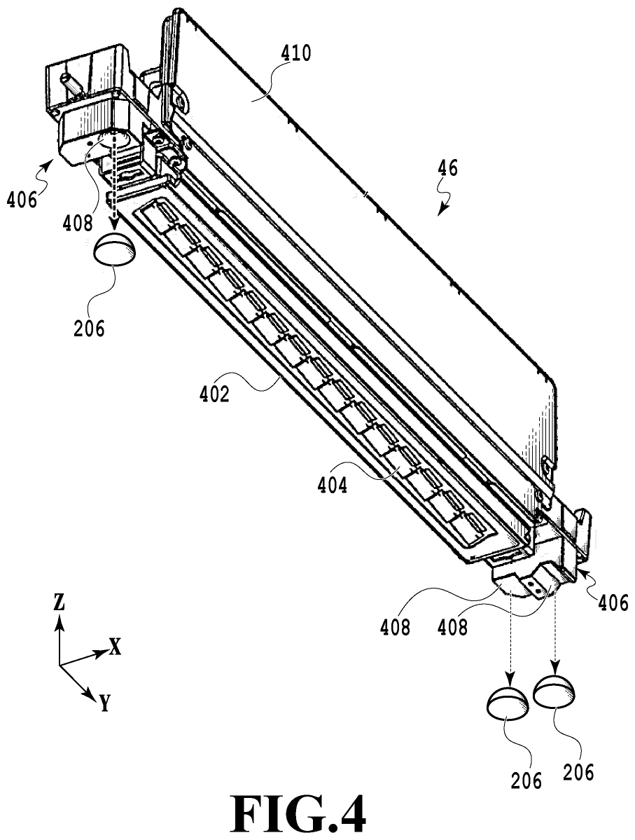

Next, the configuration of the printing portion 24 will be described. FIG. 2 is a diagram showing a conveyance path provided in the printing portion 24. FIG. 3 is a diagram showing an elevator that elevates and lowers the print head 46. FIG. 4 is a perspective view of the print head 46.

In the printing portion 24, a plurality of print heads 46 are arranged in parallel in the conveyance direction (X direction) (see FIG. 1). In the present embodiment, the printing portion 24 includes eight print heads 46 that eject printing liquids such as different types of inks. Specifically, the printing portion 24 includes a print head that ejects a black ink, a print head that ejects a cyan ink, a print head that ejects a magenta ink, and a print head that ejects a yellow ink. The printing portion 24 also includes three print heads that eject different particular color inks, respectively, and a print head that ejects a reaction liquid that reacts with these inks. The number of the print heads 46 provided in the printing portion 24 is not limited to “eight.” The types of inks ejected from the printing portion 24 are not limited to the types described above.

The print head 46 is configured to eject an ink by an inkjet method. Specifically, various known methods such as a method using a heat element, a method using a piezoelectric element, a method using an electrostatic element, and a method using a MEMS element can be adopted. Each print head 46 is supplied with a corresponding ink (liquid) from an ink tank (not shown) that stores the corresponding ink (liquid) via an ink tube or the like.

The printing portion 24 includes a conveyance path 202 through which the sheet S is conveyed (see FIG. 2). Incidentally, the conveyance path 202 forms a portion of the sheet conveyance route SCR in the printing portion 24. The conveyance path 202 includes a plurality of guide rollers 48 that support and guide the sheet S being conveyed, and positioning portions 204 that engage the print head 46 at opposite ends of each guide roller 48 in the Y direction to position the print head 46 relative to the conveyance path 202.

The guide rollers 48 and the positioning portions 204 are provided in positions corresponding to the print heads 46, and the numbers of the guide rollers 48 and the positioning portions 204 correspond to the number of print heads 46. In the present embodiment, the numbers are eight. Each positioning portion 204 includes three dome-shaped convex portions 206, and the guide roller 48 is interposed between one convex portion 206 provided on one side in the Y direction and two convex portions 206 arranged in parallel in the X direction on the other side in the Y direction.

The printing portion 24 includes, for each print head 46, an elevator 302 that can elevate and lower the print head 46 (see FIG. 3). The elevator 302 includes a holding portion 304 that holds the print head 46, and a frame portion 306 that guides the holding portion 304 so that the holding portion 304 can be elevated and lowered. The print head 46 includes a support shaft 46a that protrudes in the Y direction on opposite sides facing each other in the Y direction. The holding portion 304 axially supports the support shaft 46a from below, thereby holding the print head 46. The frame portion 306 includes an elevating-and-lowering rail 308 therein. The holding portion 304 is elevated and lowered along the elevating-and-lowering rail 308 in the frame portion 306 by a drive portion (not shown) provided in the holding portion 304.

The print head 46 is provided with a nozzle plate 404 on which a plurality of nozzles for ejecting an ink are formed on a surface 402 facing the sheet S conveyed through the conveyance path 202 (see FIG. 4). Hereafter, “the surface on which the nozzle plate 404 is provided” is also referred to as “nozzle surface.” On the nozzle surface 402, a plurality of nozzle plates 404 are arranged in parallel in the Y direction. The print head 46 includes an engagement portion 406 that can engage the positioning portion 204 at opposite ends in the Y direction. Specifically, the engagement portion 406 includes concave portions 408 formed in an engageable shape at positions where the concave portions 408 can engage the respective convex portions 206 of the positioning portion 204 in a case where the print head 46 is lowered by the elevator 302. In the print head 46, the nozzle surface 402 is interposed between one concave portion 408 provided on one side in the Y direction and two concave portions 408 arranged in parallel in the X direction on the other side in the Y direction.

In executing printing, the printing portion 24 uses the elevator 302 to lower the print head 46 from a standby position where the print head 46 is located while printing is not executed to a printing position where printing can be executed on the sheet S in the conveyance path 202. In a case where the print head 46 is lowered to the printing position, the concave portion 408 of the engagement portion 406 of the print head 46 engages the corresponding convex portion 206 of the positioning portion 204 (see FIG. 2), whereby the print head 46 is positioned relative to the conveyance path 202.

The arrangement of the convex portions 206 used for positioning is not limited to the above description, and the convex portions 206 may be arranged in any manner as long as the print head 46 can be positioned relative to the conveyance path 202. In this case, the concave portion 408 of the engagement portion 406 of the print head 46 may also be changed so as to correspond to the convex portion 206. Further, the configuration for positioning the print head 46 relative to the conveyance path 202 is not limited to the above-described configuration including the dome-shaped convex portion and the concave portion that engages the convex portion. For example, a portion of the print head 46 may be abutted against the conveyance path 202 or a pin (hole) provided in the print head 46 may be inserted into (fit to) a hole (pin) provided in the conveyance path 202.

### Nozzle Surface

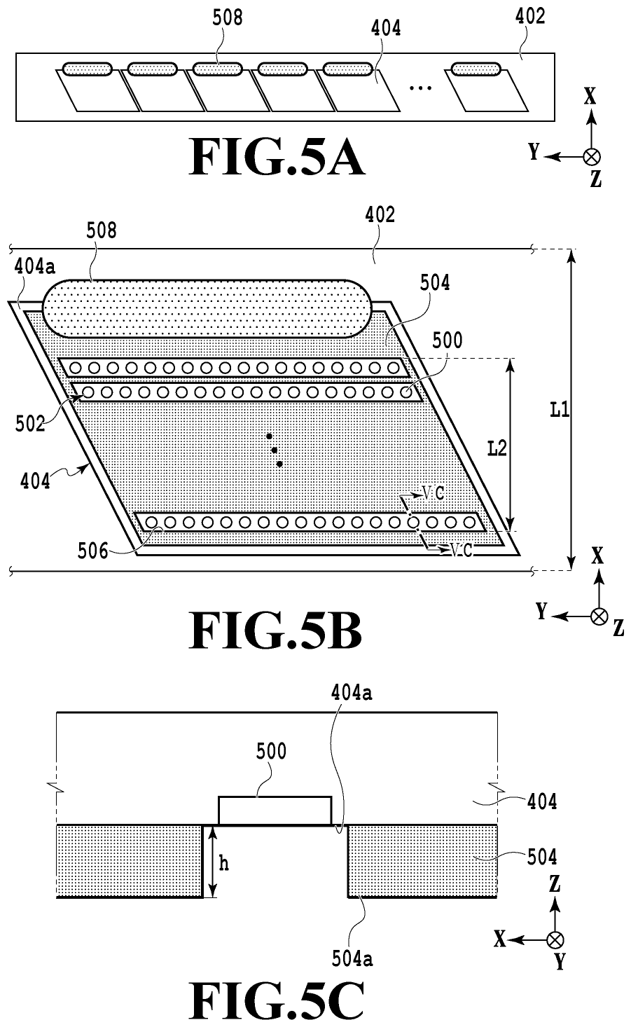

Next, the configuration of the nozzle surface 402 will be described. FIGS. 5A to 5C are diagrams for explaining the nozzle surface 402. FIG. 5A is a plan view of the nozzle surface 402, FIG. 5B is a plan view of the nozzle plate 404 provided on the nozzle surface 402, and FIG. 5C is a cross-sectional view taken along line VC-VC in FIG. 5B.

As described above, on the nozzle surface 402, the plurality of nozzle plates 404 are arranged in parallel in the Y direction (see FIG. 5A). In each nozzle plate 404, a plurality of nozzle arrays 502 formed by arranging a plurality of nozzles 500 in parallel in the Y direction are formed at predetermined intervals in the X direction. Each nozzle array 502 is formed to be displaced by a predetermined amount from an adjacent nozzle array in the Y direction. Each nozzle 500 is provided with an ejection energy generation element (not shown), and an ink (liquid) is ejected from the nozzle 500 by driving the ejection energy generation element. The nozzle plate 404 includes an electrical connection portion (not shown)

electrically connected to the ejection energy generation elements provided corresponding to the respective nozzles 500. This electrical connection portion is connected to a flexible wiring board (not shown) connected to an electrical wiring board 410 (see FIG. 4) provided in the print head 46, and the connection portion is covered with a sealing portion 508 made of resin or the like and is protected from corrosion or wire breaks. Thus, the sealing portion 508 is formed so as to protrude from the nozzle plate 404.

The surface 404a of the nozzle plate 404 is covered with a nozzle guard 504 for protecting the nozzles 500 (see FIG. 5B). The nozzle guard 504 includes a linear opening 506 that exposes an area including the nozzle array 502 to the outside for each nozzle array 502 so that an ink can be ejected from each nozzle 500. Accordingly, each nozzle 500 (nozzle array 502) provided on the surface 404a of the nozzle plate 404 is formed in a recessed position relative to the surface 504a of the nozzle guard 504. Incidentally, a difference h (see FIG. 5C) in the Z direction between the surface 504a of the nozzle guard 504 and the surface 404a of the nozzle plate 404 is 30 μm in the present embodiment but is not limited to this.

### Maintenance Portion

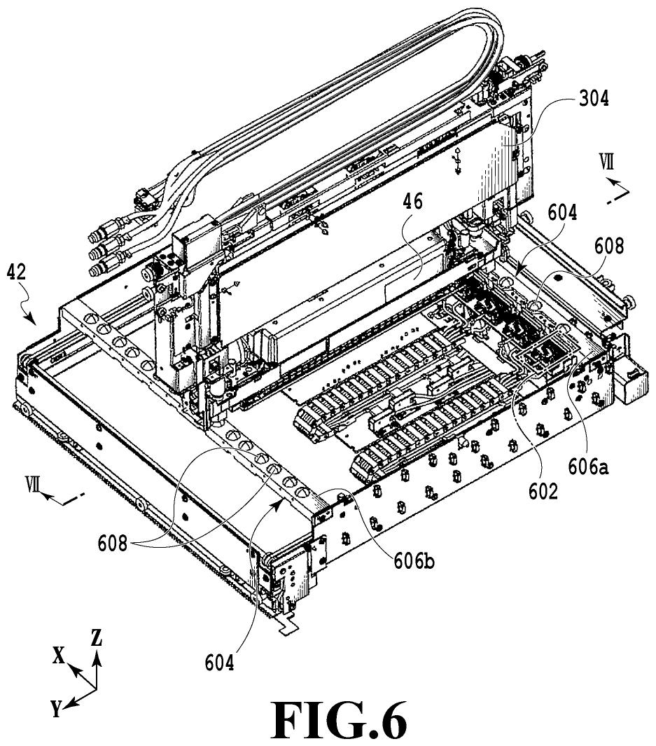

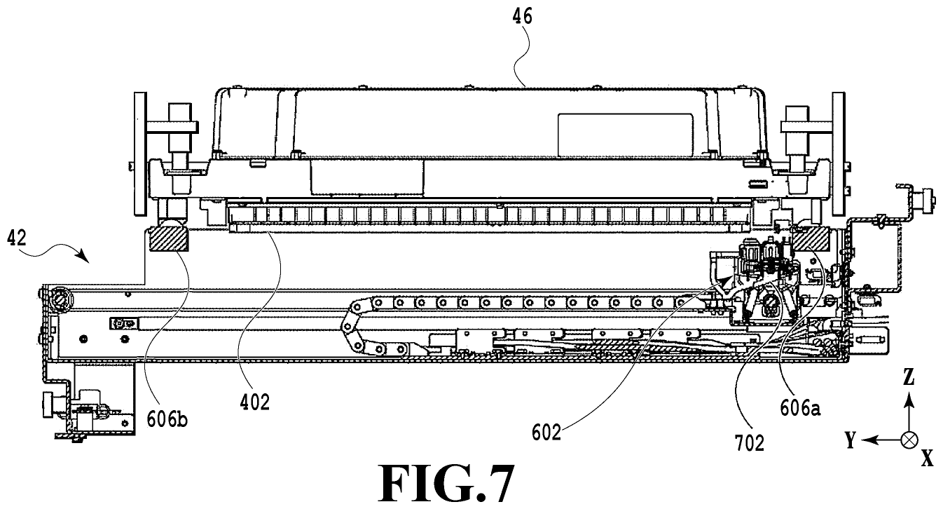

Next, the configuration of the maintenance portion 42 will be described in detail. FIG. 6 is a diagram showing the maintenance portion 42 with the print head 46 positioned. In FIG. 6, only one print head 46 is shown to facilitate understanding. FIG. 7 is a cross-sectional view taken along line VII-VII in FIG. 6.

The maintenance portion 42 includes a maintenance member 602 that removes a deposit from the nozzle surface 402 and cleans the nozzle surface 402 as one of the maintenance processes for the print head 46 (see FIGS. 6 and 7). The maintenance portion 42 also includes a positioning portion 604 that positions the print head 46 in a position where processing can be executed by the maintenance member 602. The maintenance members 602 and the positioning portions 604 are provided in positions corresponding to the respective print heads 46. Accordingly, in the present embodiment, eight maintenance members 602 and eight positioning portions 604 are provided in the X direction so as to correspond to the respective print heads 46. The maintenance members 602 are arranged to be movable in the Y direction.

The positioning portion 604 is provided in a first beam member 606a extending in the X direction on one side in the Y direction of the maintenance portion 42, and in a second beam member 606b extending in the X direction on the other side in the Y direction of the maintenance portion 42. Specifically, the positioning portion 604 includes one dome-shaped convex portion 608 provided on the first beam member 606a and two dome-shaped convex portions 608 provided in parallel in the X direction on the second beam member 606b.

In executing maintenance processing, first, the print head 46 is elevated and retracted from the movement route of the maintenance portion 42. Next, the maintenance portion 42 is moved in a-X direction from a storage position (see FIG. 1) where the maintenance portion 42 is stored while maintenance is not executed, to a processing position where the maintenance processing can be executed. After that, the print head 46 is lowered to a maintenance position where the maintenance processing is performed by the maintenance portion 42. In a case where the print head 46 is lowered to the maintenance position, the concave portion 408 of the engagement portion 406 engages the corresponding convex portion 608 of the positioning portion 604, whereby the print head 46 is positioned relative to the maintenance portion 42.

The arrangement of the convex portions 608 used for positioning is not limited to this, and the convex portions 608 may be arranged in any manner as long as the print head 46 can be positioned relative to the maintenance portion 42. In this case, the engagement portion 406 of the print head 46 may also be changed. Further, the configuration for positioning the print head 46 relative to the maintenance portion 42 is not limited to the above-described configuration including the dome-shaped convex portion and the concave portion that engages the convex portion. For example, a portion of the print head 46 may be abutted against the maintenance portion 42, or a pin (hole) provided in the print head 46 may be inserted into (fit to) a hole (pin) provided in the maintenance portion 42.

### Maintenance Member

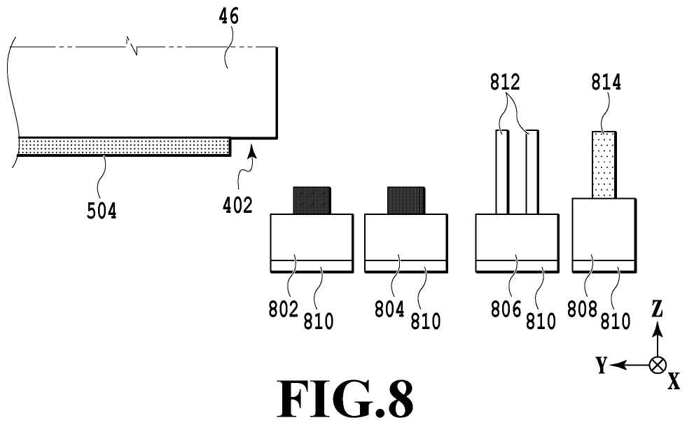

Next, the maintenance member 602 will be described. FIG. 8 is a diagram showing an example of constituent members of the maintenance member 602.

The maintenance member 602 includes a suction portion 802 that sucks an ink with negative pressure from a nozzle, a cleaning liquid application portion 804 that applies a cleaning liquid to the nozzle surface 402, and a first wiping portion 806 and a second wiping portion 808 that wipe the nozzle using a blade. The maintenance member 602 also includes a carriage 702 (see FIG. 7) that reciprocally moves the above members integrally in the Y direction. Each of the above members is also provided with an elevator 810 that can independently ascend and descend in the carriage 702.

In the present embodiment, the suction portion 802, cleaning liquid application portion 804, first wiping portion 806, and second wiping portion 808 are arranged in this order in a-Y direction. Incidentally, the arrangement positions of these members are not limited to those described above. Further, in the present embodiment, the maintenance member 602 is configured to move in the Y direction relative to the print head 46, but the present disclosure is not limited to this. For example, the print head 46 may move in the Y direction relative to the maintenance member 602, and it is only required that the print head 46 and the maintenance member 602 move relatively in the Y direction.

The suction portion 802 is connected to a pump (not shown) via a tube (not shown). The suction portion 802 applies negative pressure to the nozzle surface 402 by driving the pump and moving the suction portion 802 in the Y direction while being in contact with (or located in the vicinity of) the nozzle surface 402 and causes an ink that has thickened or stuck in the nozzles 500 and bubbles in the nozzles 500 to be discharged. In this manner, in the present embodiment, the suction portion 802 functions as a negative pressure application portion that applies negative pressure to the nozzle surface 402. The cleaning liquid application portion 804 is connected to a tank (not shown) that stores a cleaning liquid via a tube (not shown). The cleaning liquid application portion 804 is supplied with the cleaning liquid from the tank and applies the cleaning liquid to the nozzle surface 402 by moving in the Y direction while being in contact with the nozzle surface 402.

The first wiping portion 806 includes two first blades 812 made of an elastic material. The first wiping portion 806 wipes the nozzle surface 402 while applying contact force to the nozzle surface 402 by moving in the Y direction with the first blades 812 in contact with the nozzle surface 402. Although details will be described later, in the present embodiment, a wipe with the first wiping portion 806 removes an ink, paper powder, a cleaning liquid, and the like deposited on the nozzle guard 504 and the like on the nozzle surface 402. The first wiping portion 806 needs to wipe the entire nozzle surface 402. Thus, the length of the first blade 812 in the X direction (that is, a direction intersecting a movement direction in which the wiping portions 806 and 808 move) is equal to or greater than the length L1 in the X direction of the nozzle surface 402 (see FIG. 5B).

The second wiping portion 808 includes one second blade 814 made of an elastic material. The second wiping portion 808 wipes the nozzle surface 402 while applying contact force to the nozzle surface 402 by moving in the Y direction with the second blade 814 in contact with the nozzle surface 402. Although details will be described later, in the present embodiment, an ink and the like that have been stuck on the periphery of the nozzle array 502 and cannot be completely removed by the suction portion 802 are removed by a wipe with the second wiping portion 808. It should be noted that “the periphery of the nozzle array 502” means the nozzle array 502 and the periphery of the nozzle array 502 on the surface 404a of the nozzle plate 404 exposed in the opening 506, in other words, an area including the nozzles 500 and the vicinity of the nozzles 500. The second wiping portion 808 needs to wipe the periphery of the nozzle array 502 in all openings 506. Thus, the length in the X direction of the second blade 814 is equal to or greater than a length L2 from the opening 506 provided at one end in the X direction to the opening 506 provided at the other end (see FIG. 5B). Further, the length in the X direction of the second blade 814 is preferably equal to or less than the length L1 and is, for example, equal to or less than the length in the X direction of the first blade 812. The second blade 814 is formed thicker in the Y direction than the first blade 812.

In the present embodiment, the first wiping portion 806 is provided with two first blades 812, and the second wiping portion 808 is provided with one second blade 814, but the present disclosure is not limited to this. The numbers of the first blades 812 and the second blades 814 may be one or two or more.

In a start position where processing is started, the suction portion 802, the cleaning liquid application portion 804, the first wiping portion 806, and the second wiping portion 808 are each elevated by the elevator 810 to a height position (a position in the Z direction) in which these members can contact the nozzle surface 402. Thereafter, the carriage 702 moves in the Y direction, so that each member is moved in the Y direction while being in contact with (or located in the vicinity of) the nozzle surface 402.

### First Blade and Second Blade

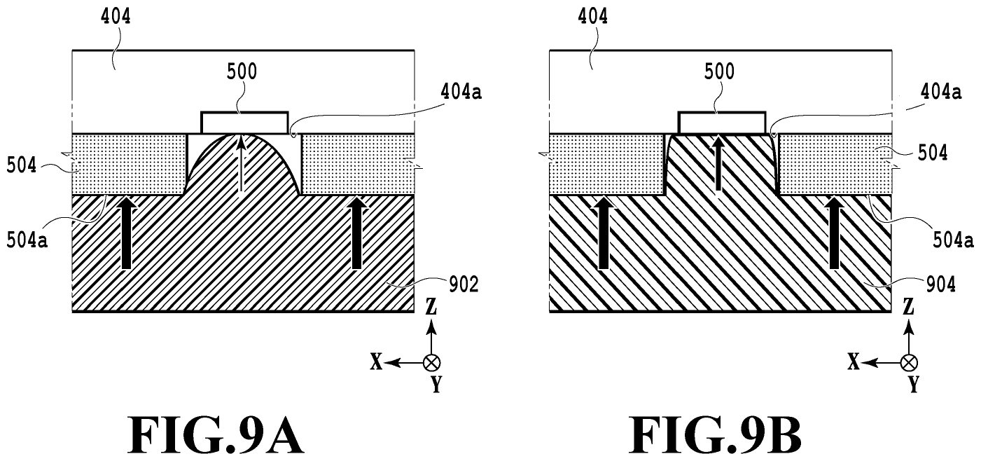

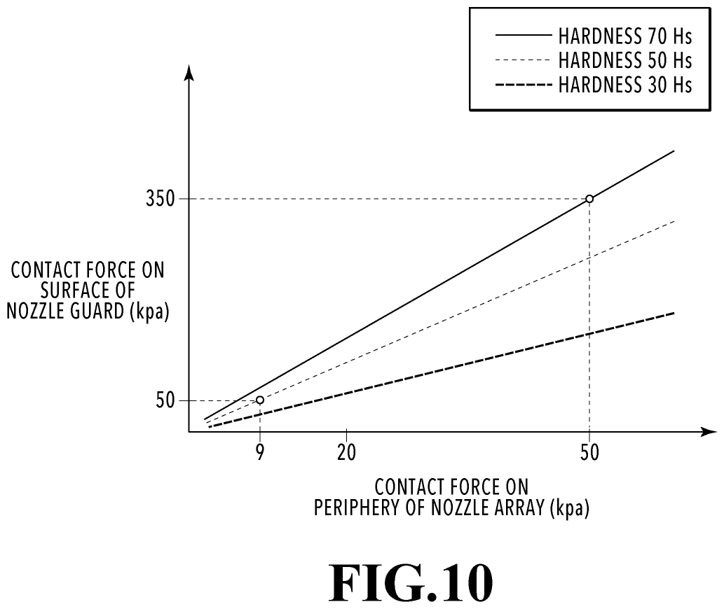

Next, the first blade 812 and the second blade 814 will be described in detail. FIGS. 9A and 9B are image diagrams of intrusion of a blade into the opening 506 during wiping. FIG. 9A shows the case of using a blade with a high hardness, and FIG. 9B shows the case of using a blade with a low hardness. FIGS. 9A and 9B correspond to FIG. 5C. FIG. 10 is a graph showing contact force on the nozzle guard 504 and contact force on the periphery of the nozzle array 502 in the case of contact with blades with different hardnesses.

As described above, the first wiping portion 806 wipes the nozzle surface 402 while applying contact force to the nozzle surface 402, thereby mainly removing an ink, paper powder, a cleaning liquid, and the like deposited on the nozzle guard 504 and the like on the nozzle surface 402. Accordingly, a wipe with the first wiping portion 806 needs to apply at least a certain level of contact force to the surface 504a in order to remove deposits such as an ink on the surface 504a of the nozzle guard 504. On the other hand, in order to suppress damage to the nozzles 500 by the first blade 812, it is necessary to apply, to the periphery of the nozzle array 502, contact force smaller than the contact force on the surface 504a.

Further, the second wiping portion 808 wipes the nozzle surface 402 while applying contact force to the nozzle surface 402, thereby mainly removing an ink that has stuck to the periphery of the nozzle array 502 within the opening 506 and cannot be completely removed by the suction portion 802. Thus, a wipe with the second wiping portion 808 needs to apply at least a certain level of contact force to the periphery of the nozzle array 502. On the other hand, it is necessary to suppress damage to another member such as the sealing portion 508 and damage to the second blade 814 itself caused by excessive contact force by the second blade 814.

Thus, in the present embodiment, different elastic materials are used for the first blade 812 and the second blade 814 according to respective applications. As a result, the first blade 812 suppresses contact force on the periphery of the nozzle array 502 while keeping the removability (cleanability) of deposits on the surface 504a. Further, the second blade 814 suppresses damage to a sealant and the second blade 814 itself while keeping the cleanability of the periphery of the nozzle array 502.

The ability to follow steps in the case of a wipe with the blade 902 having a high hardness is lower than the ability to follow steps in the case of a wipe with the blade 904 having a low hardness. That is, a wipe with the blade 902 having a high hardness makes it possible to apply large contact force to the surface 504a of the nozzle guard 504 while suppressing contact force on the periphery of the nozzle array 502 (see FIG. 9A). On the other hand, a wipe with the blade 904 having a low hardness makes it possible to apply necessary contact force to the periphery of the nozzle array 502 while suppressing contact force on the surface 504a (see FIG. 9B).

Accordingly, in the present embodiment, the first blade 812 is formed using an elastic material with a high hardness, and the second blade 814 is formed using an elastic material with a low hardness. Since the first blade 812 and the second blade 814 are moved in the Y direction while applying contact force to the nozzle surface 402, it is preferable that the first blade 812 and the second blade 814 have a minimum hardness of, for example, 10 Hs or more that allows contact force on the nozzle surface 402 to be designed. Further, it is preferable that the first blade 812 and the second blade 814 have a deformable hardness of, for example, 90 Hs or less. Specifically, it is preferable that the first blade 812 be formed of an elastic material with a hardness of 70 Hs or more and 90 Hs or less, and the second blade 814 be formed of an elastic material with a hardness of 10 Hs or more and 50 Hs or less.

Here, FIG. 10 shows a relationship between contact force on the surface 504a of the nozzle guard 504 and contact force on the periphery of the nozzle array 502 in three blades with hardnesses of 70 Hs, 50 Hs, and 30 Hs in the case of wipes under the same condition. It can be seen from FIG. 10 that the lower the hardness is, the smaller a difference between contact force on the surface 504a and contact force on the periphery of the nozzle array 502 is. Specifically, in the case of a hardness of 70 Hs, contact force on the surface 504a is 350 kPa in a case where contact force on the periphery of the nozzle array 502 is 50 kPa, and the difference is 300 kPa. Further, in the case of a hardness of 50 Hs, contact force on the periphery of the nozzle array 502 is 9 kPa in a case where contact force on the surface 504a is 50 kPa, and the difference is 41 kPa.

Incidentally, in applying sufficient contact force to the periphery of the nozzle array 502, a blade is scraped at a step portion, which accelerates damage to and wear in the blade, and further increases the possibility that scraped blade pieces enter the nozzles 500 and cause defective ejection. For example, in a case where the blade also has a high wear rate, damage to the blade during wiping is even greater. However, without a minimum dynamic friction coefficient, even in a case where sufficient contact force is applied, the blade slides over sticking matter to be removed, and cleanability decreases. Thus, it is preferable that the dynamic friction coefficient be 0.1 or more.

Similarly, regarding a loss tangent tan 8 (E′/E″), which is a parameter obtained as a dynamic elastic modulus measurement, in a case where the loss tangent tan 8 is small, energy stored in a material itself is low, which results in low wear resistance. Incidentally, E′ is a storage modulus that reflects the elastic property of the material, and E″ is a loss modulus that reflects the viscous property of the material. That is, by using an elastic material with a low dynamic friction coefficient and a large loss tangent tan 8 as an elastic material forming a blade, damage and wear powder are less likely to occur in the blade.

Accordingly, the second blade 814 that ensures contact force on the periphery of the nozzle array 502 is formed using an elastic material with a low dynamic friction coefficient and a large loss tangent in order to suppress the generation of excessive contact force on the surface 504a or the like while suppressing damage to the second blade 814 itself and the generation of wear powder. Specifically, the dynamic friction coefficient of the second blade 814 is made lower than the dynamic friction coefficient of the first blade 812, and the loss tangent of the second blade 814 is made higher than the loss tangent tan 8 of the first blade 812. Incidentally, the dynamic friction coefficient of the second blade 814 is preferably, for example, 0.1 or more and 0.7 or less. The loss tangent of the second blade 814 is preferably, for example, 0.1 or more and 0.3 or less.

### Wiping Process

In the above configuration, as one of the maintenance processes, the printing apparatus 10 executes a cleaning process in which the maintenance member 602 wipes off any deposit deposited on the nozzle surface 402 to perform cleaning. In the present embodiment, the cleaning process includes a first cleaning process executed with high frequency and a second cleaning process executed with low frequency.

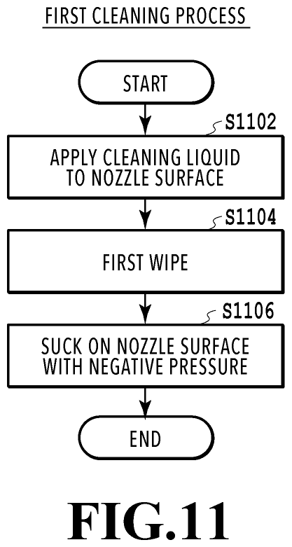

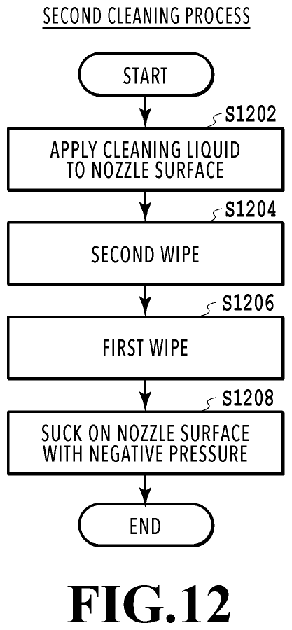

FIG. 11 is a flowchart showing the processing contents of the first cleaning process, and FIG. 12 is a flowchart showing the processing contents of the second cleaning process. A series of steps shown in the flowcharts in FIG. 11 and FIG. 12 is performed by a controller provided in the control portion 44 developing a program code stored in the ROM into the RAM and executing the program code. Alternatively, a portion or all of the functions of the steps in FIG. 11 and FIG. 12 may be executed by hardware such as an ASIC or an electric circuit. To facilitate understanding, the following description is made on the assumption that a subject that performs each step in each flowchart is the control portion 44. In the present specification, a symbol S in the description of each process in a flowchart means a step in the flowchart.

### First Cleaning Process

The first cleaning process is executed, for example, at a timing at which a certain time has elapsed after power is turned on, at a timing at which the printing apparatus 10 is started up, at a timing at which predetermined printing is ended, at a timing at which a specific error occurs, or the like. The timing at which the first cleaning process is executed is not limited to the above-described timings.

In a case where the first cleaning process is started, first, in S1102, the control portion 44 applies a cleaning liquid to the nozzle surface 402 with the cleaning liquid application portion 804. Specifically, the maintenance member 602 is moved to a start position where the process is started and then moved in the Y direction after the cleaning liquid application portion 804 is elevated by the elevator 810, so that the cleaning liquid application portion 804 is moved while being in contact with the nozzle surface 402. As a result, the cleaning liquid is applied to the nozzle surface 402, and the sticking force of an ink stuck to the nozzle surface 402 is reduced.

Next, in S1104, the control portion 44 performs a first wipe with the first wiping portion 806. Specifically, the maintenance member 602 is moved to the start position and then moved in the Y direction after the first wiping portion 806 is elevated by the elevator 810, so that the first blade 812 is moved while being in contact with the nozzle surface 402. Here, as described above, the first blade 812 is formed of an elastic material with a high hardness. Thus, in the first wipe, although the contact force of the first blade 812 on the surface 504a of the nozzle guard 504 is high, the contact force on the periphery of the nozzle array 502 is low (see FIG. 9A). As a result, in the first wipe, the first blade 812 removes deposits such as an ink and a cleaning liquid deposited on the surface 504a, the sealing portion 508, and the like.

During the first wipe, the thickness and length of the first blade 812 and the amount of elevation by the elevator 810 are adjusted so that the contact force of the first blade 812 on the surface 504a is within a predetermined range (for example, 20 kPa or more and 50 kPa or less). During the first wipe, it is preferable that the first blade 812 do not contact the nozzle array 502, but as long as there is no effect or a small effect on the nozzles 500, a certain level of contact force may be applied to the nozzle array 502.

Thereafter, in S1106, the control portion 44 causes the suction portion 802 to suck on the nozzle surface 402 with negative pressure and ends this first cleaning process.

Specifically, the maintenance member 602 is moved to the start position and then moved in the Y direction after the suction portion 802 is elevated by the elevator 810, so that the suction portion 802 is moved while acting on the nozzle surface 402. This causes an ink stuck within the nozzles 500, minute bubbles within the nozzles 500, and the like to be discharged.

Although not specifically described, in the first cleaning process described above, the maintenance member 602 may be moved in the Y direction only once to execute the process in S1102, S1104, and S1106. Alternatively, the maintenance member 602 may be moved in the Y direction multiple times to execute the process. In the first wipe, the nozzle surface 402 may be wiped in the case of movement from one side to the other side in the Y direction, or the nozzle surface 402 may be wiped in the case of bidirectional movement in the Y direction from one side to the other side and from the other side to the one side.

In the first cleaning process, three steps are executed in this order: the step of applying a cleaning liquid in S1102, the first wipe in S1104, and the step of discharging an ink and bubbles from the nozzles 500 in S1106. However, the present disclosure is not limited to this. At least one of S1102 and S1106 may be omitted, or the order of the steps may be changed.

### Second Cleaning Process

The second cleaning process is executed, for example, at a timing at which a certain time has elapsed after power is turned on, at a timing at which the printing apparatus 10 is started up, at a timing at which predetermined printing is ended, at a timing at which a specific error occurs, or the like. The timing at which the second cleaning process is executed is not limited to the above-described timings. Further, the second cleaning process is intended to remove ink-sticking matter that accumulates on the periphery of the nozzle array 502 over time as the printing apparatus 10 is used and that cannot be removed in the first cleaning process. Thus, the second cleaning process is set to be executed with less frequency than the first cleaning process.

In a case where the second cleaning process is started, first, in S1202, the control portion 44 causes the cleaning liquid application portion 804 to apply a cleaning liquid to the nozzle surface 402. The specific processing contents are the same as those of S1102 described above.

Next, in S1204, the control portion 44 gives a second wipe with the second wiping portion 808. Specifically, the maintenance member 602 is moved to the start position and then moved in the Y direction after the second wiping portion 808 is elevated by the elevator 810, so that the second blade 814 is moved while being in contact with the nozzle surface 402. Here, as described above, the second blade 814 is formed of an elastic material having a low hardness, a low dynamic friction coefficient, and a large loss tangent. Thus, in the second wipe, even in a case where the contact force of the second blade 814 on the periphery of the nozzle array 502 is increased to the extent that sticking matter can be removed, contact force on the surface 504a and the sealing portion 508 is suppressed, and no excessive contact force is applied (see FIG. 9B). As a result, in the second wipe, the second blade 814 removes sticking matter around the nozzle array 502 while suppressing damage to and wear in the second blade 814. During the second wipe, the thickness and length of the second blade 814 and the amount of elevation by the elevator 810 are adjusted so that the contact force of the second blade 814 on the periphery of the nozzle array 502 is within a predetermined range (for example, 20 kPa or more and 50 kPa or less).

Here, in the first wipe, deposits are removed from the surface 504a, and in the second wipe, deposits are removed from the periphery of the nozzle array 502. Thus, the contact force of the first blade 812 on the surface 504a and the contact force of the second blade 814 on the periphery of the nozzle array 502 are equal or approximate to each other. Accordingly, although the second blade 814 has a lower hardness than that of the first blade 812, in the second wipe, the contact force of the second blade 814 on the surface 504a is equal to or greater than the contact force of the first blade 812 on the surface 504a during the first wipe (see FIG. 10). The contact force of the first blade 812 on the surface 504a during the first wipe is, for example, 20 kPa or more and 50 kPa or less. Further, the contact force of the second blade 814 on the surface 504a during the second wipe is, for example, 20 kPa or more and 350 kPa or less.

Thereafter, in S1206, the control portion 44 performs the first wipe with the first wiping portion 806. In S1208, the control portion 44 then causes the suction portion 802 to suck on the nozzle surface 402 with negative pressure and ends this second cleaning process. The specific processing contents of S1206 and S1208 are the same as those of S1104 and S1106 described above. Thus, in the second cleaning process, the second blade 814 comes into contact with the nozzles 500 during the second wipe, and there is a possibility of damaging the nozzles 500, so that the second cleaning process is executed with low frequency. Further, the occurrence of damage to the nozzles 500 due to the contact of the second blade 814 is suppressed by forming the second blade 814 using an elastic material with a low hardness.

Although not specifically described, in the second cleaning process described above, the maintenance member may be moved in the Y direction only once to execute the process in S1202, S1204, S1206, and S1208. Alternatively, the maintenance member 602 may be moved in the Y direction multiple times to execute the process. In the first wipe and the second wipe, the nozzle surface 402 may be wiped in the case of movement from one side to the other side in the Y direction, or the nozzle surface 402 may be wiped in the case of bidirectional movement in the Y direction from one side to the other side and from the other side to the one side.

In the second cleaning process, four steps are executed in this order: the step of applying a cleaning liquid in S1202, the second wipe in S1204, the first wipe in S1206, and the step of discharging an ink and bubbles from the nozzles 500 in S1208. However, the execution of each step is not limited to this. At least one of S1202, S1206, and S1208 may be omitted, or the processing order of the steps may be changed.

### Verification Experiment

Next, an experiment conducted by the present inventors will be described. The present inventors conducted an experiment to verify, in the case of changing the elastic material used for the first blade 812 and the second blade 814, cleanability indicating the effect of removing deposits by wiping, and durability against damage to and wear in the blades and nozzle surface due to wiping. In the present experiment, the cleanability and durability were verified for a total of seven samples including four examples and three comparative examples.

### Cleanability Evaluation

In cleanability evaluation, cleanability was evaluated in a case where an ink was deposited on the entire surface of the nozzle surface 402 including the nozzle guard 504 and the periphery of the nozzle array 502 and where the print head 46 was left in a 50° C. environment for four hours to solidify the ink.

More specifically, the state of ink-sticking matter remaining on the surface 504a of the nozzle guard 504 was evaluated after the first cleaning process was executed on the print head 46 in which an ink had been solidified. After that, after the second cleaning process was executed on the print head 46 after the evaluation, the state of ink-sticking matter remaining on the periphery of the nozzle array 502 was evaluated.

Regarding the state of the ink-sticking matter remaining on the surface 504a, in a case where the ratio of the area of a portion of the surface 504a where sticking matter deposited to the total area of the surface 504a was 5% or less, an evaluation result was OK (the evaluation result was “GOOD” or “EXCELLENT”), and in a case where the ratio was greater than 5%, the evaluation result was poor (the evaluation result was “POOR”). Regarding the state of ink-sticking matter remaining on the periphery of the nozzle array 502, in a case where the ratio of the number of nozzles 500 on which sticking matter remained to the total number of the nozzles 500 was 1% or less, the evaluation result was OK, and in a case where the ratio was greater than 1%, the evaluation result was poor.

### Durability Evaluation

In durability evaluation, after the first cleaning process was executed 2,500 times and the second cleaning process was executed 150 times, the condition of the sealing portion 508, the condition of the blades, the condition of the nozzles 500, and the condition of dot mis-alignment during ink ejection were evaluated.

Regarding the condition of the sealing portion 508, the sealing portion 508 formed to protrude relatively from the nozzle surface 402 was observed, and in a case where the thickness of the sealing portion 508 was 95% or more of the thickness before the evaluation and there was no noticeable defect such as a chip, the evaluation result was OK. On the other hand, in a case where the thickness of the sealing portion 508 was less than 95% of the thickness before the evaluation or in a case where there was a noticeable defect such as a chip, the evaluation result was poor.

Regarding the condition of the blades, the first blade 812 and the second blade 814 were observed, and in a case where the thicknesses of the two blades were 95% or more of the thicknesses before the evaluation, respectively, and there was no noticeable defect such as a chip, the evaluation result was OK. In a case where the thickness of at least one of the first blade 812 and the second blade 814 was less than 95% of the thickness before the evaluation or there was a noticeable defect such as a chip, the evaluation result was poor.

Regarding the condition of nozzles, in a case where the ratio of the number of deformed or clogged nozzles 500 to the total number of the nozzles 500 was 0.5% or less, the evaluation result was OK, and in a case where the ratio was greater than 0.5%, the evaluation result was poor.

Regarding the condition of dot misalignment during ink ejection, the amount of deviation from the normal landing position of an ink ejected from each nozzle 500 was measured in printed matter printed after the first cleaning process and the second cleaning process were executed. In a case where the value of σ of a normal distribution in a case where the total number of the nozzles 500 was used as a population was 10 or less, the evaluation result was OK, and in a case where the value of σ of the normal distribution was greater than 10, the evaluation result was poor.

### Conditions

The thickness and length of the first blade 812 and the amount of elevation by the elevator 810 are adjusted so that the contact force of the first wiping portion 806 on the nozzle guard 504 is within the range of 20 kPa to 50 kPa during a wipe with the first wiping portion 806. This is because it is necessary to set a certain range of contact force in the apparatus configuration with consideration given to the intersection of the apparatus and materials, the deflection and inclination of the apparatus, and the like. During the wipe with the first wiping portion 806, it is preferable that the first blade 812 do not contact the nozzle array 502. However, in a case where there are no problems as a result of observation of the nozzles 500 in the durability evaluation, a certain degree of contact force (for example, 9 kPa or less) may be applied to the periphery of the nozzle array 502.

During a wipe with the second wiping portion 808, the thickness and length of the second blade 814 and the amount of elevation by the elevator 810 are adjusted so that the contact force of the second wiping portion 808 on the periphery of the nozzle array 502 is within a range of 20 kPa to 50 kPa. This is also because, in the apparatus configuration, it is necessary to set a certain range of contact force with consideration given to the intersection of the apparatus and materials, the deflection and inclination of the apparatus, and the like.

In the present experiment, the contact force of the first blade 812 on the surface 504a of the nozzle guard 504 and the contact force of the second blade 814 on the periphery of the nozzle array 502 were each set to 20 kPa, and the cleanability and durability of each sample were evaluated. Further, the contact force of the first blade 812 on the surface 504a of the nozzle guard 504 and the contact force of the second blade 814 on the periphery of the nozzle array 502 were each set to 50 kPa, and the cleanability and durability of each sample were evaluated. It should be noted that the present experiment was conducted at an environmental temperature of 25° C.

### Examples and Comparative Examples

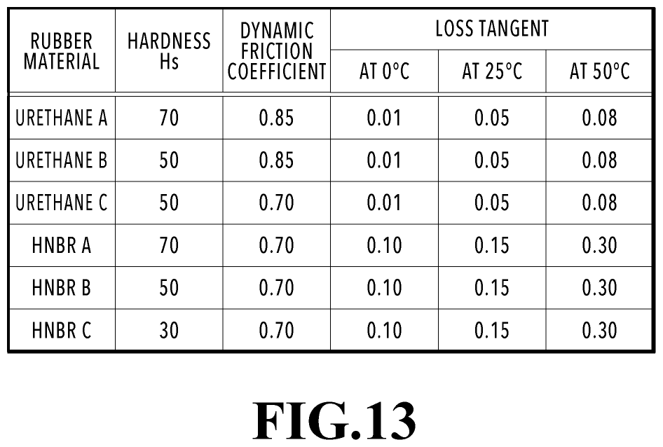

In examples and comparative examples, six types of rubber materials were used as elastic materials forming the first blade 812 and the second blade 814. FIG. 13 is a table showing the hardness, dynamic friction coefficient, and loss tangent value of each rubber material used in the examples and comparative examples.

The rubber materials used were urethane rubbers Urethane A, Urethane B, and Urethane C, and hydroxylated nitrile rubbers (HNBR) HNBR A, HNBR B, and HNBR C. Urethane A has a hardness of 70 Hs, a dynamic friction coefficient of 0.85, and a loss tangent (25° C.) of 0.05. Urethane B has a hardness of 50 Hs, a dynamic friction coefficient of 0.85, and a loss tangent (25° C.) of 0.05. Urethane C has a hardness of 50 Hs, a dynamic friction coefficient of 0.70, and a loss tangent (25° C.) of 0.05. HNBR A has a hardness of 70 Hs, a dynamic friction coefficient of 0.70, and a loss tangent (25° C.) of 0.15. HNBR B has a hardness of 50 Hs, a dynamic friction coefficient of 0.70, and a loss tangent (25° C.) of 0.15. HNBR C has a hardness of 30 Hs, a dynamic friction coefficient of 0.70, and a loss tangent (25° C.) of 0.15.

### Examples

In Example 1, the first blade 812 was made of Urethane A (hardness: high; dynamic friction coefficient: high; loss tangent: low), and the second blade 814 was made of HNBR B (hardness: medium; dynamic friction coefficient: low; loss tangent: high). It should be noted that “high,” “medium,” and “low” for the hardness, dynamic friction coefficient, and loss tangent in the parentheses indicate the relative levels of the six materials shown in the table in FIG. 13.

In Example 2, the first blade 812 was made of Urethane A (hardness: high; dynamic friction coefficient: high; loss tangent: low), and the second blade 814 was made of HNBR C (hardness: low; dynamic friction coefficient: low; loss tangent: high).

In Example 3, the first blade 812 was made of Urethane A (hardness: high; dynamic friction coefficient: high; loss tangent: low), and the second blade 814 was made of Urethane C (hardness: medium; dynamic friction coefficient: low; loss tangent: low).

In Example 4, the first blade 812 was made of HNBR A (hardness: high; dynamic friction coefficient: low; loss tangent: high), and the second blade 814 was made of HNBR B (hardness: medium; dynamic friction coefficient: low; loss tangent: high).

### Comparative Examples

In Comparative Example 1, the first blade 812 was made of Urethane A (hardness: high; dynamic friction coefficient: high; loss tangent: low), and the second blade 814 was made of Urethane B (hardness: medium; dynamic friction coefficient: high; loss tangent: low).

In Comparative Example 2, the first blade 812 was made of HNBR A (hardness: high; dynamic friction coefficient: low; loss tangent: high), and the second blade 814 was made of HNBR A (hardness: high; dynamic friction coefficient: low; loss tangent: high).

In Comparative Example 3, the first blade 812 was made of HNBR B (hardness: medium; dynamic friction coefficient: low; loss tangent: high), and the second blade 814 was made of HNBR B (hardness: medium; dynamic friction coefficient: low; loss tangent: high).

### Evaluation Results

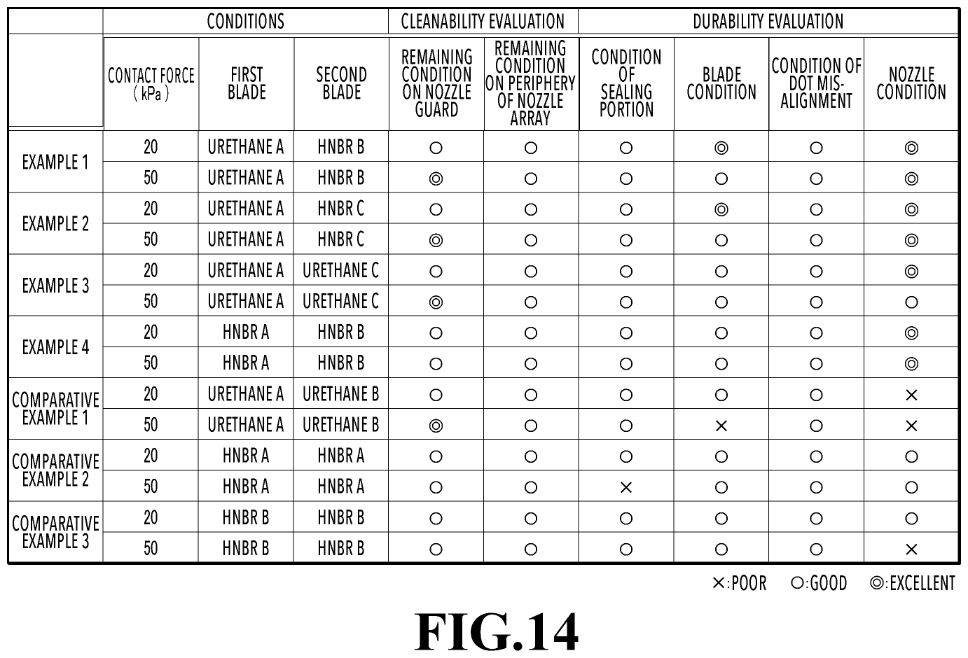

The evaluation results of the present experiment are shown in FIG. 14. FIG. 14 is a table showing experimental conditions for each sample and the evaluation results of each sample. In FIG. 14, in a case where the evaluation result is OK, “GOOD” is used, and in a case where the evaluation result is poor, “POOR” is used for each evaluation item. Additionally, among items whose evaluation results were OK, those received significantly better evaluations are denoted by “EXCELLENT.”

### Example 1 and Example 2

In Example 1 and Example 2, the evaluation results of the cleanability evaluation were OK in a case where the contact force was 20 kPa and in a case where the contact force was 50 kPa. Specifically, in a case where the contact force was 50 kPa, a significantly good evaluation was obtained in the state of ink-sticking matter remaining on the surface 504a of the nozzle guard 504. In Examples 1 and 2, the second blade 814 had a lower hardness than that of the first blade 812. As a result, in the first cleaning process, it was possible to apply sufficient contact force to the surface 504a while suppressing contact force on the periphery of the nozzle array 502. In the second cleaning process, it was possible to apply contact force sufficient to remove sticking matter to the periphery of the nozzle array 502 without significantly increasing the contact force on the surface 504a.

Further, in Examples 1 and 2, evaluation results for all durability evaluation items were OK. Specifically, in a case where the contact force was 20 kPa, the evaluation result of the blade condition was remarkably good. Furthermore, the evaluation result of the nozzle condition was remarkably good regardless of the contact force. It is considered that this is because the second blade 814 was made of a comb material with a dynamic friction coefficient of 0.7 and a loss tangent of 0.15, that is, a low dynamic friction coefficient and a high loss tangent.

### Example 3

In Example 3, the evaluation results of the cleanability evaluation were OK in a case where the contact force was 20 kPa and in a case where the contact force was 50 kPa. Specifically, in a case where the contact force was 50 kPa, a significantly good evaluation was obtained in the state of ink-sticking matter remaining on the surface 504a of the nozzle guard 504. It is considered that in Example 3, it was possible to obtain good evaluation results for the same reason as that in Examples 1 and 2.

Further, in Example 3, evaluation results for all durability evaluation items were OK. Specifically, in a case where the contact force was 20 kPa, the evaluation result of the nozzle condition was remarkably good. In Example 3, the second blade 814 was made of a rubber material with a dynamic friction coefficient of 0.7 and a loss tangent of 0.05, that is, a low dynamic friction coefficient and a low loss tangent. In Example 3, the loss tangent of the second blade 814 was smaller than those of Examples 1 and 2, which is considered to result in reduced wear resistance, and slight damage to the blade and clogging of the nozzle with blade wear powder were observed, which were within the criteria for an OK evaluation.

As compared to Examples 1 and 2, in Example 3, a rubber material used for the second blade 814 had a lower loss tangent, so that the durability evaluation of the blade condition and the nozzle condition partially degraded.

### Example 4

In Example 4, the evaluation results of the cleanability evaluation were OK in a case where the contact force was 20 kPa and in a case where the contact force was 50 kPa. It is considered that in Example 4, it was possible to obtain good evaluation results for the same reason as that in Examples 1 and 2.

Further, in Example 4, evaluation results for all durability evaluation items were OK. Specifically, the evaluation result of the nozzle condition was remarkably good regardless of the contact force. It is considered that this is because the second blade 814 was made of a comb material with a dynamic friction coefficient of 0.7 and a loss tangent of 0.15, that is, a low dynamic friction coefficient and a high loss tangent. In Example 4, the state of ink-sticking matter remaining on the surface 504a of the nozzle guard 504 was slightly inferior to that in Examples 1 to 3. Specifically, since sufficient contact force was applied to the surface 504a, although sticking matter itself on the surface 504a was successfully peeled off, only a small portion of the peeled off sticking matter remained on the surface 504a. It is considered that this is because since the first wiping portion 806 is designed to wipe the entire surface of the nozzle surface 402 over a wide area and the dynamic friction coefficient of the first blade 812 was relatively lower than those of Examples 1 to 3, the sticking matter that had been peeled off during wiping slid and remained on the surface 504a.

As compared to Examples 1 and 2, in Example 4, a rubber material used for the first blade 812 had a high dynamic friction coefficient, which resulted in a decrease in the evaluation of the state of ink-sticking matter remaining on the surface 504a in terms of cleanability and the blade condition in terms of durability.

### Comparative Example 1

In Comparative Example 1, the evaluation results of the cleanability evaluation were OK in a case where the contact force was 20 kPa and in a case where the contact force was 50 kPa. Specifically, in a case where the contact force was 50 kPa, a significantly good evaluation was obtained in the state of ink-sticking matter remaining on the surface 504a of the nozzle guard 504. It is considered that in Comparative Example 1, it was possible to obtain good evaluation results for the same reason as that in Examples 1 and 2.

Further, in Comparative Example 1, in a case where the contact force was 50 kPa, in terms of durability, the evaluation result of the blade condition was poor, and the evaluation result of the nozzle condition was poor regardless of the contact force. Evaluation results for the other items were OK. In Comparative Example 1, the second blade 814 was made of a rubber material with a dynamic friction coefficient of 0.85 and a loss tangent of 0.05, that is, a high dynamic friction coefficient and a low loss tangent. That is, it is considered that in Comparative Example 1, since the dynamic friction coefficient was higher than those of Examples 1 to 3 and the loss tangent was lower than those of Examples 1 and 2, the wear resistance decreased and damage to the blade, clogging of the nozzles with blade wear powder were observed, and some of evaluation results for the evaluation items were poor.

### Comparative Example 2

In Comparative Example 2, the evaluation results of the cleanability evaluation were OK in a case where the contact force was 20 kPa and in a case where the contact force was 50 kPa. It is considered that in Comparative Example 1, it was possible to obtain good evaluation results for the same reason as that in the examples.

In Comparative Example 2, in a case where the contact force was 50 kPa, the evaluation result of the condition of the sealing portion was poor in terms of durability. In Comparative Example 2, both the first blade 812 and the second blade 814 used a rubber material with a hardness of 70 Hs. Thus, in a case where the second blade 814 applied a contact force of 50 kPa to the periphery of the nozzle array 502, contact force of about 350 kPa acted on the surface 504a (see FIG. 10). It is considered that this caused friction to be promoted due to excessive pressure applied to the surface 504a and the sealing portion 508 by the second blade 814, which resulted in the evaluation result of the condition of the sealing portion being poor.

### Comparative Example 3

In Comparative Example 3, the evaluation results of the cleanability evaluation were OK in a case where the contact force was 20 kPa and in a case where the contact force was 50 kPa. It is considered that in Comparative Example 1, it was possible to obtain good evaluation results for the same reason as that in the examples.

Further, in Comparative Example 3, in a case where the contact force was 50 kPa, the evaluation result of the nozzle condition was poor in terms of durability. In Comparative Example 3, both the first blade 812 and the second blade 814 used a rubber material with a hardness of 50 Hs. Thus, in a case where the first blade 812 applied contact force of 50 kPa to the surface 504a, contact force of about 9 kPa acted on the periphery of the nozzle array 502 (see FIG. 10). A wipe with the first blade 812 was given not only in the first cleaning process executed with high frequency, but also in the second cleaning process executed with low frequency. Accordingly, the number of wipes with the first blade 812 was significantly greater than the number of wipes with the second blade 814. As a result, it is considered that at least a certain level of contact force on the periphery of the nozzle array 502 by the first blade 812 was accumulated, which caused deformation or clogging of the nozzles 500 and resulted in the evaluation result of the nozzle condition being poor.

### Verification Results

The verification results of the present experiment show that a high hardness was suitable for the elastic material forming the first blade 812. It is also shown that by making the elastic material forming the second blade 814 lower in hardness, lower in dynamic friction resistance, and higher in loss tangent than the elastic material forming the first blade 812, it was possible to achieve both cleanability and durability.

### Functions and Effects

As described above, in the present embodiment, the nozzle surface 402 of the print head 46 is wiped with two wiping portions provided with different blades. One blade is made of an elastic material with a hardness suitable for wiping the entire nozzle surface 402. The other blade is provided with such a property that generates no excessive pressure on the surface 504a or the sealing portion 508 of the nozzle guard 504 while wiping the periphery of the nozzle array 502 located in a recessed position in the opening 506 of the nozzle guard 504. Specifically, the other blade is made of an elastic material with a lower hardness, a lower dynamic friction coefficient, and a higher loss tangent than those of the one blade. As a result, the printing apparatus 10 according to the present embodiment can keep sufficient cleanability while suppressing damage to a nozzle surface configuration and wear in the blades.

### OTHER EMBODIMENTS

In the above embodiment, a high-speed line printer has been described as an example of an image forming apparatus according to the present disclosure, but the technique according to the present disclosure can be applied to any image forming apparatus as long as the technique includes a configuration in which printing is performed by an inkjet printing method. For example, the technique according to the present disclosure may be applied to printers using various known line heads, or to printers using serial heads.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image forming apparatus comprising:
a printing unit configured to eject a printing liquid from a nozzle to perform printing; and
a maintenance unit configured to wipe a nozzle surface on which the nozzle is formed in the printing unit to remove a deposit deposited on the nozzle surface, wherein the maintenance unit comprises:
a first wiping portion configured to give a first wipe with a first blade made of an elastic material; and
a second wiping portion configured to give a second wipe with a second blade made of an elastic material different from that of the first blade,
wherein the second blade has a hardness lower than that of the first blade and is formed thicker than the first blade.

2. The image forming apparatus according to claim 1, wherein the first blade is made of an elastic material having a hardness of 70 Hs or more and 90 Hs or less.

3. The image forming apparatus according to claim 1, wherein the second blade is made of an elastic material having a hardness of 10 Hs or more and 50 Hs or less.

4. The image forming apparatus according to claim 1, wherein the first wipe is given with higher frequency than the second wipe.

5. The image forming apparatus according to claim 1, wherein the second blade has a dynamic friction coefficient lower than that of the first blade.

6. The image forming apparatus according to claim 5, wherein the dynamic friction coefficient of the second blade is 0.1 or more and 0.7 or less.

7. The image forming apparatus according to claim 1, wherein the second blade has a loss tangent higher than that of the first blade.

8. The image forming apparatus according to claim 7, wherein the loss tangent of the second blade is 0.1 or more and 0.3 or less.

9. The image forming apparatus according to claim 1, wherein the nozzle surface is provided with a nozzle guard protecting the nozzle so that the printing liquid can be ejected, and
contact force of the first blade on a surface of the nozzle guard in the first wipe and contact force of the second blade on the nozzle exposed from the nozzle guard and a vicinity of the nozzle in the second wipe are equal or approximate to each other.

10. The image forming apparatus according to claim 9, wherein the contact force of the second blade on the surface of the nozzle guard in the second wipe is equal to or greater than the contact force of the first blade on the surface of the nozzle guard in the first wipe.

11. The image forming apparatus according to claim 9, wherein the contact force of the first blade on the nozzle exposed from the nozzle guard and the vicinity of the nozzle in the first wipe is 9 kPa or less.

12. The image forming apparatus according to claim 9, wherein the contact force of the second blade on the surface of the nozzle guard in the second wipe is 20 kPa or more and 350 kPa or less.

13. The image forming apparatus according to claim 9, wherein the contact force of the second blade on the nozzle exposed from the nozzle guard and the vicinity of the nozzle in the second wipe is 20 kPa or more and 50 kPa or less.

14. The image forming apparatus according to claim 9, wherein the contact force of the first blade on the surface of the nozzle guard in the first wipe is 20 kPa or more and 50 kPa or less.

15. The image forming apparatus according to claim 1, wherein a length of the second blade in a direction intersecting a moving direction in which the second wiping portion moves during the second wipe is equal to or less than a length of the first blade in the direction.

16. The image forming apparatus according to claim 1, wherein the maintenance unit further comprises:
a negative pressure application unit configured to apply negative pressure to the nozzle surface; and
a cleaning liquid application unit configured to apply a cleaning liquid to the nozzle surface.

17. A control method for controlling an image forming apparatus comprising a printing unit configured to eject a printing liquid from a nozzle to perform printing and a maintenance unit configured to wipe a nozzle surface on which the nozzle is formed in the printing unit to remove a deposit deposited on the nozzle surface, wherein the maintenance unit comprises a first wiping portion configured to give a first wipe with a first blade made of an elastic material and a second wiping portion configured to give a second wipe with a second blade made of an elastic material different from that of the first blade, the method comprising:
a first process in which the first wipe is given is executed with high frequency; and
a second process in which the first wipe and the second wipe are given is executed with low frequency.

18. A control method for controlling an image forming apparatus comprising a printing unit configured to eject a printing liquid from a nozzle to perform printing and a maintenance unit configured to wipe a nozzle surface on which the nozzle is formed in the printing unit to remove a deposit deposited on the nozzle surface, wherein the maintenance unit comprises a first wiping portion configured to give a first wipe with a first blade made of an elastic material a second wiping portion configured to give a second wipe with a second blade made of an elastic material different from that of the first blade, a negative pressure application unit configured to apply negative pressure to the nozzle surface, and a cleaning liquid application unit configured to apply a cleaning liquid to the nozzle surface, the method comprising:
a first process in which a step of applying the cleaning liquid to the nozzle surface with the cleaning liquid application unit, the first wipe, and a step of applying negative pressure to the nozzle surface with the negative pressure application unit are performed is executed with high frequency; and
a second process in which the step of applying the cleaning liquid to the nozzle surface with the cleaning liquid application unit, the second wipe, the first wipe, and the step of applying negative pressure to the nozzle surface with the negative pressure application unit are performed is executed with high frequency.
